(19) United States
(12) Patent Application Publication
(10) Pub. No.: US 2025/0096401 A1
(43) Pub. Date: Mar. 20, 2025

(54) BATTERY CELL

(71) Applicants: W. L. Gore & Associates GmbH, Putzbrunn (DE); Volkswagen Aktiengesellschaft, Wolfsburg (DE)

(72) Inventors: Tim DAGGER, Lingen (DE); Daniel KEGLMEIER, Putzbrunn (DE); Anton KILLER, Putzbrunn (DE); Paul MEISTER, Ilsede (DE); Joachim MUELLER, Putzbrunn (DE); Andreas SAENGER, Putzbrunn (DE); Piotr WRZUSZCZAK, Hannover (DE); Wenbo ZHANG, Calberlah (DE); Branislav ZLATKOV, Braunschweig (DE)

(73) Assignees: W. L. Gore & Associates GmbH, Putzbrunn (DE); Volkswagen Aktiengesellschaft, Wolfsburg (DE)

(21) Appl. No.: 18/965,474

(22) Filed: Dec. 2, 2024

Related U.S. Application Data
(63) Continuation of application No. PCT/EP2023/061639, filed on May 3, 2023.

(30) Foreign Application Priority Data
May 30, 2022 (DE) 10 2022 205 366.4

(51) Int. Cl. H01M 50/342; H01M 50/30

(52) U.S. Cl. CPC H01M 50/3425; H01M 50/394; H01M 2220/20

(57) ABSTRACT

A battery cell having a cell casing in which a number of electrodes are arranged. The cell casing has a rupture region. The rupture region having an opening. The opening being covered by a gas-permeable membrane.

This nonprovisional application is a continuation of International Application No. PCT/EP2023/061639, which was filed on May 3, 2023, and which claims priority to German Patent Application No. 10 2022 205 366.4, which was filed in Germany on May 30, 2022, and which are both herein incorporated by reference.

### BACKGROUND OF THE INVENTION

### Field of the Invention

The invention relates to a battery cell. The battery cell has a cell casing in which a number of electrodes are arranged.

### Description of the Background Art

Increasingly, motor vehicles are at least partially powered by an electric motor, so that they are designed as electric vehicles or hybrid vehicles. To power the electric motor, a high-voltage battery is generally used, which includes a number of individual battery modules. The battery modules are usually identical in construction and electrically connected to each other in series and/or in parallel, so that the electrical voltage applied to the high-voltage battery corresponds to a multiple of the electrical voltage provided by each of the battery modules. Each battery module, in turn, comprises a number of battery cells, which are usually arranged in a common module casing and which are electrically connected to each other in series and/or in parallel.

Each of the battery cells, in turn, comprises several galvanic elements. These have two electrodes each, namely an anode and a cathode, as well as a separator arranged between them and an electrolyte with freely movable charge carriers. A liquid, for example, is used as such an electrolyte. In an alternative, the battery cell is designed as a solid-state battery, and the electrolyte is present as a solid. The anode and cathode, which form the electrodes of the battery cell, usually comprise a carrier that acts as a current collector. An active material is usually attached to it, which is part of a layer applied to the carrier, also known as a collector. In this case, it is possible that the electrolyte is already present in the layer, or that it is introduced later. At the very least, however, the active material is suitable for absorbing the working ions, e.g., lithium ions. Depending on its use as an anode or cathode, a different material is used for the carrier and a different type of material of the layer.

To protect the galvanic elements, they are usually arranged in a cell casing of the battery cell, which is also known as a cell can. The electrolyte is also protected from environmental influences by means of the cell casing. In order to provide a comparatively large capacity by means of the respective battery cell, usually a number of such galvanic elements, typically up to 100 of them, are arranged in the common cell casing. In order to make comparatively efficient use of the available space and to simplify production, the individual components of the galvanic elements are designed flat and stacked on top of each other in one stacking direction, so that an essentially cuboid cell stack is formed. In an example, the separator can have a ribbon-shaped design and a number of electrodes on opposite sides. The ribbon is wound into a roll, in particular a so-called “jelly roll”. Thus, the galvanic elements are rolled up to form a cylindrical shape.

The cell casing is shaped depending on the arrangement of the galvanic elements used. It is possible to design it rigidly and make it from aluminum, for example. Here, for example, the shape of the cell casing is cuboid. Such a battery cell is also called a prismatic cell. In an example, the cell casing can be created by means of a foil that is wrapped around the galvanic elements. Such a battery cell is also known as a so-called pouch cell.

When the battery cell is in operation, i.e., during charging and discharging, it is possible that gases are produced due to undesirable chemical reactions. As a result, pressure within the cell casing increases, so that on the one hand individual electrodes can be de-contacted, leading to a loss of performance of the battery cell. On the other hand, it is possible that the cell casing is deformed due to the increased pressure, so that the environment of the battery cell in particular is mechanically affected. At a comparatively high pressure, the cell casing bursts, so that the electrolyte is able to escape and the complete battery cell is no longer operational. It is also possible that undesirable chemical reactions of the individual components of the battery cell with the environment take place.

In order to avoid such gas formation, a special selection of the individual materials of the electrodes is required, which on the one hand increases production costs. On the other hand, with such materials, the capacity of the battery cell is reduced. Alternatively, for example, there are additional elements in the cell casing by means of which the resulting gases are bound and/or converted. In another variant, the cell casing is designed to be comparatively robust, so that the pressure that leads to the cell casing breaking is never reached when the battery cell is in operation. However, due to the additional elements and the robust design of the cell casing, the installation space and also the weight of the battery cell is increased, which is why energy density is reduced.

### SUMMARY OF THE INVENTION

It is therefore an object of the invention to provide a particularly suitable battery cell, advantageously increasing operational reliability and/or energy density.

In an example, the battery cell is designed to be rechargeable and is conveniently a secondary battery. Preferably, the battery cell is a component of a motor vehicle in its intended state. The battery cell is suitable for this purpose, in particular intended and equipped. In its intended state, for example, the battery cell is a component of a motor vehicle energy storage unit that has a number of such battery cells. Preferably, the battery cells are divided into several battery modules, which in turn are identical. In particular, the battery cells are arranged in a casing of the energy storage unit or the respective battery module and connected to each other electrically in parallel and/or in series. Thus, the electrical voltage applied to the energy storage/battery module is a multiple of the electrical voltage provided by each of the battery cells. Expediently, all battery cells are identical, which simplifies production.

The casing of the energy storage unit or the respective battery module, which thus form a composite of such battery cells in particular, is preferably made of a metal, such as a steel, such as a stainless steel, or an aluminum alloy. For example, a die-casting process, deep-drawing process, casting or extrusion is used for production. In particular, the casing of the energy storage unit or the respective battery module is designed to be locked. Conveniently, an interface is inserted into the casing of the energy storage unit or the respective battery module, which forms a connection for the energy storage unit/battery module. The interface is electrically contacted to the battery cells, so that electrical energy can be fed in and/or electrical energy can be removed from the battery cells from outside the energy storage unit, provided that a corresponding plug is plugged into the connector.

The motor vehicle can be land-based and can have a number of wheels, of which at least one, suitably several or all, are driven by means of a drive. In particular one, preferably several, of the wheels is designed to be controllable. Thus, it is possible to move the motor vehicle independent of a specific track, for example, rails or the like. It is useful to position the motor vehicle essentially arbitrarily on a roadway that is made of asphalt, in particular, tar or concrete. The motor vehicle is, for example, a commercial vehicle, such as a truck or a bus. Particularly preferably, however, the motor vehicle is a passenger car.

The drive is expediently used to move the motor vehicle. For example, the drive, especially the main drive, is at least partly electric, and the motor vehicle is, for example, an electric vehicle. The electric motor, for example, is operated by means of the energy storage unit, which is suitably designed as a high-voltage battery. The high-voltage battery is used to provide an electrical direct voltage, wherein the electrical voltage is, for example, between 200 V and 800 V and, for example, essentially 400 V. Preferably, an electric inverter is arranged between the energy storage unit and the electric motor, by means of which the current of the electric motor is adjusted. In an alternative, the drive also has a combustion engine, so that the motor vehicle is designed as a hybrid motor vehicle. In an alternative, the energy storage unit is used to supply a low-voltage electrical system of the motor vehicle, and the energy storage unit is used to provide an electrical DC voltage of 12 V, 24 V or 48 V.

The battery cell can also be a component of an industrial vehicle, an industrial installation, a handheld device, such as a tool, especially a cordless screwdriver. In another alternative, the battery cell is a component of an energy supply and is used, for example, as a so-called buffer battery. In another alternative, the battery cell is a component of a handheld device, such as a portable cellular phone, or other handheld device. It is also possible to use such a battery cell in the camping sector, in model building or for other outdoor activities.

The battery cell has several electrodes, for example two or preferably more. In particular, the electrodes are divided into anodes and cathodes, with half of the electrodes expediently forming the anodes and the other half the cathodes. Preferably, however, there is one more anode than cathode. It is particularly preferable that all anodes and all cathodes are identical to each other, which simplifies production. The electrodes, for example, are designed to be flat and have a carrier in particular, which is also known as a collector. In particular, the respective carrier is formed by means of a metal foil coated on one or both sides with a layer, at least in sections. For example, aluminum is used as the metal for the carrier/collector of the cathodes and copper as the metal for the collector of the anodes.

The layer has a thickness of less than 1 mm. Conveniently, the carriers have a thickness of less than 0.1 mm. Preferably, the respective layer has an active material, a binding agent and/or a conductive additive, such as conductive carbon black. The active material is used to accommodate working ions, such as lithium ions, and is suitable, intended and equipped for this purpose. For example, a lithium metal oxide, such as lithium cobalt (III) oxide (LiCoO2), NMC, e.g., NMC622 or NMC811, NCA, LMNO or LFP is used as an active material for the cathode, and/or LTO or graphite, Si-based, is used for the anode.

In particular, the electrodes are essentially rectangular in shape. For example, the electrodes are stacked on top of each other to form a stack of cells, wherein the stacking direction is perpendicular to the direction of expansion of the electrodes, which are arranged parallel to each other. Here, the anodes and cathodes preferably alternate in the stacking direction of the cell stack. Conveniently, a separator of the cell stack is arranged between adjacent electrodes, i.e., in particular between one of the anodes of one of the cathodes, respectively, which preferably also has a flat design. For example, all separators are identical to each other. In particular, the electrodes are essentially stacked on top of each other, wherein, for example, all anodes slightly protrude beyond the cathodes. Particularly preferred, the protrusion is greater on one of the sides. Preferably, the cathodes also protrude beyond the anodes on one side, with the (enlarged) protrusion being located on opposite sides of the cell stack. This makes it easier to contact the anodes and cathodes with other components. Due to the stacking of the electrodes, the cell stack is therefore also essentially cuboid.

In an example, all anodes, all cathodes or the separator can be formed by means of a common strip, or these are attached to a common strip. The strip itself is rolled up into a cylindrical shape or the like, so that a so-called “jelly roll” is formed.

The battery cell can have a cell casing within which the electrodes are arranged, such as the cell stack or the “jelly roll”. Appropriately, the cell casing has a base body within which the electrodes are arranged. The base body is, for example, in the shape of a pot and closed by means of a cover of the cell casing. This simplifies the arrangement of the electrodes. In particular, a volume of between 0.1 dm3 and 10 dm3 is encased by means of the cell casing, preferably the base body. For example, the cell casing is also at least partially filled with an electrolyte, or the electrolyte is already partially formed by means of the respective active material, for example. The cell casing, especially the possible base body, is preferably rigidly designed. In other words, the battery cell is a prismatic cell. In particular, the cell casing, preferably the base body and/or any cover, is made of a metal such as aluminum, i.e., pure aluminum or an aluminum alloy. The cell casing, especially the base body, has a cuboid shape, for example. Alternatively, the cell casing, and preferably the base body, is flexibly designed and, for example, at least partially formed by means of a metal foil, which is coated on one or both sides. The electrodes are folded over by means of the metal foil and the metal foil is conveniently sealed at the ends to prevent the electrolyte from escaping and/or ambient air from entering the cell casing.

In particular, the electrodes can be arranged directly in the cell casing, so that the electrodes directly adjoin an inner wall of the cell casing, for example, or via another component, and are thus stabilized by means of it. At the very least, the cell casing directly serves to protect the electrodes and/or prevent the electrodes/electrolytes from coming into contact with ambient air or other particles. In other words, the electrodes within the cell casing are preferably not surrounded, at least not completely, by another component, so that the weight of the battery cell and material costs are reduced. In particular, there is no other casing in the cell casing by which the electrodes are surrounded. Consequently, it is possible to fill the cell casing essentially completely with the electrodes and any separators.

Appropriately, the cell casing can have at least one or two openings, through each of which a connector is passed. By means of the connector(s), at least some of the electrodes arranged in the cell casing are electrically contacted, so that the supply and/or withdrawal of electrical energy from outside the cell casing to or from the galvanic elements formed by means of the electrodes is possible via the connector(s). If there is only a single connector, at least some of the electrodes are electrically contacted to the cell casing, so that the electrical potential of the cell casing is specified by means of these electrodes. In particular, the connector(s) are electrically insulated from the cell casing, with the connectors being fluid-tight with the cell casing, so that the electrolyte is prevented from escaping in the area of the connectors.

The cell casing, especially the base body, can have a rupture region. The rupture region thus covers a certain area of the cell casing, especially the base body. The rupture region is designed in such a way that it breaks at a certain pressure difference between the inner and the outer of the cell casing, so that in particular a mass exchange between the inner of the cell casing and the environment is possible. The breaking of the rupture region is irreversible. For example, if the pressure difference is exceeded, which is also referred to below in particular as bursting pressure, the rupture region breaks completely or only partially. In particular, the area of the rupture region that breaks and is thus opened depends on the actual pressure difference.

In particular, the cell casing can be designed in such a way that if the bursting pressure is exceeded, the cell casing initially breaks only in the area of the rupture region, while the remaining components of the cell casing, especially the base body, remain intact. These are only damaged in the event of a further increase in pressure difference and in this case break, in particular, uncontrollably. The bursting pressure is preferably chosen in such a way that it is less than the pressure difference between the pressure inside the cell casing and the pressure outside the cell casing that leads to a destruction of the cell casing, such as complete bursting or breaking. Preferably, the bursting pressure is between 70% and 90%, between 75% and 85% or 80% of this pressure difference.

The rupture region can have an opening that is arranged in particular in a central area, i.e., offset inwards from an edge of the rupture region. Appropriately, the distance of the opening to an edge of the rupture region is greater than a quarter of the expansion of the rupture region in the respective direction. In particular, the opening is located exactly in the middle of the rupture region. The area of the opening is smaller than the area of the rupture region and in particular less than 50%, 20%, 10%, 5%, 1% or 0.1% thereof.

The opening can be covered by a membrane that is gas-permeable. In particular, the membrane is rigid, i.e., immovably connected to the cell casing, preferably to the base body and/or the rupture region, so that movement of the membrane with respect to the cell casing/base body is avoided. The area of the membrane is at least equal to the area of the opening or preferably larger, so that the membrane completely overlaps the opening. In particular, the area of the membrane is smaller than the area of the complete rupture region. In this way, material costs are reduced. The membrane area can also be optimized independently of the area of the rupture region with regard to the necessary active area and its connection to the rupture region/cell casing. Alternatively, the area is larger than the area of the rupture region, and the membrane overlaps the rupture region. In this way, when the membrane is attached to the cell casing, especially at the edge, the rupture region is not affected.

The membrane can be arranged in such a way that the passage of liquids and/or gas between the membrane and the rupture region is avoided. In other words, the membrane is connected to the cell casing in a gas- and fluid-tight manner, for example directly or via other components. Particularly preferably, for this purpose the membrane is welded with the cell casing, e.g., the rupture region, suitably with a circumferential weld. For this purpose, for example, an ultrasonic, laser or temperature welding process is used. Alternatively, for example, the membrane is connected to the cell casing in a form-fitting and/or material-tight manner, in particular glued. In this case, the opening is conveniently completely surrounded by means of the adhesive or weld seam. For example, the connector is directly adjacent to the opening, or a spacing is formed between the opening and the connector of the membrane to the cell casing, for example the adhesive or the weld. As a result, gas can only escape from or into the cell casing through the opening, wherein the gas also passes through the membrane.

The membrane can be selected in such a way that it is permeable to CO, CO2, H2 and/or CH4. For example, the passage of such gases is not obstructed by means of the membrane, or only to a comparatively small extent. However, the permeability of the membrane to moisture, especially to water vapor, is preferably much lower. In particular, the membrane has a ratio of C02 permeability to moisture permeability of at least 0.5, at least 1 or at least 1.5. Preferably, the ratio is more than 0.5 and less than 3. In particular, the membrane acts as a barrier to moisture entering the cell casing, in particular water vapor. In summary, the membrane is designed in such a way that gases produced in the cell casing can pass through it, through the opening, out of the cell casing, for which the opening is used. By means of the membrane, the entry of liquids, especially water, into the cell casing is made more difficult or significantly reduced.

Due to the gas-permeable membrane, continuous degassing of the cell casing is essentially possible, so that the formation of a pressure difference between a pressure outside the cell casing and a pressure inside the cell casing, in particular due to an unintentional formation of gases in the cell casing during operation of the battery cell, is avoided or slowed down. Due to the comparatively small area of the opening, on the one hand, the mechanical integrity of the cell casing is only marginally reduced. On the other hand, it is only in this area that the penetration of foreign substances, such as moisture or liquids, into the cell casing is generally possible, which is comparatively unlikely. This means that the battery cell can be operated comparatively safely over a comparatively long period of time, so that operational reliability is increased. In other words, if the battery cell is operating undisturbed, there is no excessive accumulation of gases inside the cell casing due to the essentially continuous discharge through the membrane, so that the pressure difference between the environment of the cell casing and the interior of the cell casing remains comparatively small.

If, however, due to unwanted chemical reactions in the cell casing, for example during an overload, the pressure difference increases comparatively strongly and quickly, so that the resulting gases cannot be sufficiently discharged through the opening and the membrane, the rupture region breaks and the cell casing is opened at a defined point, namely in the rupture region. Consequently, uncontrolled damage to the cell casing and uncontrolled influence on the environment is avoided. Rather, this only occurs in the area of the rupture region, and it is therefore possible to adapt the installation situation of the battery cell to this. This increases operational safety.

The membrane can be made of a polymer in particular and can be a film, for example a polymer film. Appropriately, the membrane is made of PTFE, i.e., a polytetrafluoroethylene, or consists of it. Expediently, the membrane has a crystallinity between 85% and 100% and a density between 0.2 g/cm3 and 2 g/cm3. With such a choice of material, gas permeability is given, wherein the membrane prevents or at least makes it more difficult for moisture, especially water vapor, to penetrate the cell casing. A membrane suitable for battery applications is described in WO 2021/079163 A1. For example, the membrane is flat. In this way, production is simplified and weight is reduced.

For example, the rupture region/opening is positioned anywhere on the cell casing. However, if the battery cell is designed as a pouch cell, this is particularly preferably located in the area of one of the ends of the cylinder shape near the collector in which the possible foil is sealed (e.g., on the so-called gas pocket). In this case, the rupture region/opening is conveniently offset inwards from the respective ends to a maximum of one third of the maximum length of the cell casing.

If the battery cell is a prismatic cell, the rupture region/opening can be located in the area of the front and/or narrow sides, which are in particular not parallel to the electrodes layered to form the possible cell stack. Alternatively, the opening is located in one of the sides of the cell casing, which is parallel to the electrodes, but preferably in an edge area, i.e., offset inwards from the edge to a maximum of one third of the width of the side. Due to such a position of the opening, construction is simplified and there is no need to modify the existing design draft of the cell stack. Furthermore, the rupture region/opening is located in an area where the resulting gas collects, so that a comparatively efficient removal of the gases through the opening is possible. For example, the rupture region has the only opening covered by the membrane. Alternatively, the rupture region comprises several such openings, each of which is covered by the membrane. Here, for example, the membrane is designed to be continuous, or each of the openings is assigned a corresponding (separate) membrane.

The rupture region, for example, is designed to be stadium-shaped, round or rectangular. In particular, an area of the rupture region is between 0.01 cm2 and 20 cm2 and preferably between 0.1 cm2 and 10 cm2. Appropriately, the rupture region has a size of 0.01% and 50% of the area of the cell casing. Preferably, the rupture region has a size between 0.1% and 40% and in particular between 0.3% and 30% of the area of the complete cell casing. For example, the membrane has a surface area that is 50% larger than the opening. Appropriately, the opening has an area of 50 μm2 to 15 mm2, preferably from 0.2 mm2 to 3 mm2.

The opening can be covered with an additional gas-permeable, hydrophobic, i.e., at least water repellent, membrane. Preferably, the contact angle of the material of the additional membrane with water is greater than 80°, 90° or 100°, especially if the material is also exposed to air or is located in ambient air. By means of the additional membrane, moisture is thus kept away from the membrane, which is why an ingress of moisture into the cell casing is further hindered. At the very least, however, moisture penetrating from the outside is kept out by means of the additional membrane.

In particular, the two membranes can be arranged in parallel, and the additional membrane conveniently covers the membrane completely. Preferably, the additional membrane is attached to the cell casing, for example the rupture region, in a fluid-tight manner. For example, the opening is directly covered with the additional membrane, and the additional membrane is attached directly to the cell casing. In this case, the membrane is offset inwards, especially in relation to the rupture region or at least the additional membrane, so that the opening is covered on both sides by the two membranes. This also protects the membrane by means of the membrane and prevents water (vapor) from hitting it. Arranging the two membranes on both sides of the rupture region also simplifies the design, and the two membranes are conveniently attached to the cell casing in a fluid-tight manner. Alternatively, for example, the position of the additional membrane and the membrane is reversed. In another alternative, the additional membrane and the membrane are located on the same side with respect to the cell casing/rupture region, and by means of the additional membrane, the membrane in particular is covered, so that the opening is also covered. In particular, the additional membrane is offset to the outside in relation to the membrane, so that the membrane is protected by the additional membrane. In this way, it is also possible to choose a comparatively large area of the additional membrane to be used for gas passage. For example, the additional membrane is attached to the membrane, and by means of this, in particular, a kind of laminate or sandwich is provided. In this way, production is simplified.

For example, the membrane can be designed to be tear-proof. However, the membrane is particularly preferred to be designed in such a way that it tears when the pressure difference between the pressure outside the cell casing and the pressure inside the cell casing exceeds a first limit value. Due to the tearing, gas passage through the membrane or at least the opening is accelerated, so that the pressure within the cell casing is relieved comparatively quickly. In this way, damage to the cell casing is avoided. For example, if the first limit value is exceeded, the membrane tears completely and is thus destroyed, i.e., ruptured. This effectively uses the entire area of the opening for gas passage, so that the pressure difference can be reduced comparatively quickly. As an alternative or in combination to the tearing of the membrane, for example, if the first limit value or an additional limit value is exceeded, the fluid-tight connection of the membrane to the cell casing is partially lifted. This also allows for the gases to escape there, which leads to a reduction in the pressure difference.

The first limit value is appropriately less than the bursting pressure, which is a second limit value. The rupture region is thus designed in such a way that it breaks when the pressure difference between the pressure outside the cell casing and the pressure inside the cell casing exceeds the second limit value, which is greater than the first limit value. For example, the first limit value is between 90% and 50% of the second limit (bursting pressure), between 80% and 60% of the second limit value (bursting pressure) and, for example, substantially equal to 70% of the second limit value (bursting pressure). Thus, in the event of an excessive increase in pressure, the membrane is initially at least partially destroyed, whereas the rupture region remains intact. This means that the battery cell can continue to be operated in the future. If, on the other hand, the pressure difference does not remain below the bursting pressure despite the membrane tearing, the rupture region bursts, preventing the cell casing from tearing open elsewhere.

For example, the membrane can be attached to an outer side of the cell casing, for example to the outside of the rupture region or a possible base body. In this way, the membrane does not fill the inner space of the cell casing, so that a comparatively large volume is available for the electrodes. This increases the capacity of the battery cell. It is also possible in this way to choose an area of the membrane that is larger than the area of the opening. After the gases have passed through the opening, an enlarged surface area is thus available for them to pass through the membrane.

The membrane may rest on the side facing away from the cell casing on a stabilizing element that has several additional openings. In particular, the spatial degrees of freedom for the membrane are delimited by means of the stabilizing element, thus additionally stabilizing the membrane at increased pressure. In other words, the stabilizing element specifies a maximum deformation of the membrane and thus stabilizes the membrane. Thus, stability of the membrane itself is not required, or at least the requirements for this are reduced, so that there are no restrictions on the choice of material used for the membrane in this respect. Conveniently, the stabilizing element completely covers the membrane. The stabilizing element is preferably rigidly designed and made of metal, for example. In particular, the stabilizing element is designed in the form of a grid, by means of which the additional openings are formed. Due to the additional openings, undisturbed gas passage through the stabilizing element is possible.

For example, the stabilizing element can be designed in such a way that it breaks in the event of an increased pressure difference between the pressure inside the cell casing and the pressure outside the cell casing. The magnitude of the pressure difference at which this occurs can be set comparatively accurately. Due to the breaking, the membrane is no longer stabilized and thus also overloaded, so that it tears. As a result, a comparatively large volume of gas can pass through the wider opening. Appropriately, the pressure difference corresponds to the possible first limit value.

For example, the stabilizing element can be attached to the cell casing at a distance from the rupture region. In this way, damage to the rupture region is avoided during production due to the stabilizing element being connected to it, thus reducing scrap and manufacturing costs. In this way, the rupture region is also stabilized, at least in part, by means of the stabilizing element, which reduces restrictions in the choice of material or the geometry of the rupture region. Alternatively, the stabilizing element is attached to the rupture region. In this way, the need for space is reduced.

The membrane can also be arranged on an inward-facing side of the rupture region. In other words, the membrane is offset inside the cell casing in relation to the rupture region. In this way, even at a comparatively high pressure inside the cell casing, the membrane does not bulge excessively outwards if the design of the membrane does not allow for the gases to pass through immediately. In this case, the membrane is at least partially pressed against the inward-facing side of the rupture region. Consequently, the membrane is stabilized by means of the rupture region, which increases robustness. Also, at an overpressure, the membrane is pressed against the rupture region, and the passage of gas between the rupture region and the membrane is thus prevented, which increases tightness in this area. Consequently, the gas is only able to escape through the membrane, which thus takes place in a controlled manner.

For example, the membrane can be attached directly to the inward-facing side of the rupture region. In this way, it is also possible to connect the membrane to the rupture region over a comparatively large area, so that tightness in this area is increased. However, particularly preferred, the membrane is supported via spacers on the rupture region. This means that the membrane does not lie against the rupture region or only at the edge and is separated from the rupture region in other areas by means of the spacers. As a result, an enlarged area of the membrane is prepared for gas passage, so that the volume of gases that can be passed through the membrane is increased. For example, it is possible for some of the gases to enter the space formed between the membrane and the rupture region, which is defined by the spacers, through the membrane, and only then enter the vicinity of the battery cell through the opening. In summary, by means of the spacers, the membrane does not cover the entire area, but only part of the area, i.e., for example selectively or in certain areas, so that a comparatively large space is formed between the membrane and the rupture region.

The spacers, for example, are at least partially dome-like or web-like, so that they also stabilize the membrane, which is therefore not excessively deformed even with a comparatively large pressure difference. Here, for example, the membrane is directly attached to the edge of the cell casing, or the membrane is supported via another circumferentially designed spacer at the edge of the cell casing, for example on the rupture region. The spacers are attached, for example, to the rupture region. However, the spacers are particularly preferably attached to the membrane and especially molded to it. This provides a fluid-tight connection between the membrane and the spacers. This also simplifies production. In particular, the spacers are made of the same material as the membrane and are produced in a joint step, for example in an injection molding or lamination process. In another alternative, the spacers and the membrane are separate components that are joined together during assembly. Preferably, the fluid-tight attachment of the membrane to the rupture region is carried out by some of the spacers, especially the one at the edges. Alternatively, the membrane is attached directly to the edge of the rupture region, wherein the membrane is spaced from the rupture region in the other areas by the spacers.

For example, it is possible that the base body has an additional opening. The base body, for example, is rigid, so that the battery cell is a prismatic cell. Alternatively, the base body is at least partially elastic, and the battery cell is a pouch cell. A rupture disc is inserted into the additional opening, so that the opening is closed with the rupture disc. For example, the rupture disc is made of a metal, such as aluminum, or a plastic. The rupture disc is a separate component from the base body, which is attached to the cell casing during assembly. In particular, the rupture disc is connected to the cell casing in a gas- and fluid-tight manner, preferably attached, for example, by welding and/or gluing. The rupture disc is round, for example, and in particular essentially flat. In this case, the rupture disc is expediently arranged parallel to any side of the cell casing that has the additional opening. Alternatively, the rupture disc is partly concave or convex, in order to increase compressive strength. The rupture region conveniently comprises the rupture disc. For example, the rupture region is formed by means of the rupture disc, or the rupture region has further components. However, the rupture disc preferably at least closes the opening. In particular, the rupture disc breaks when the rupture pressure is exceeded and the rupture disc is selected accordingly. With the rupture disc, a prefabricated component is available that is inserted into the additional opening during assembly to provide the intended rupture point. This simplifies assembly. It is also possible to adjust the bursting pressure to the respective application by selecting the appropriate rupture disc.

Conveniently, the membrane is attached to the rupture disc, for example by means of gluing and/or welding. For this purpose, for example, an ultrasonic, laser or temperature weld process is used. Due to the attachment of the membrane to the rupture disc, it is possible to manufacture this composite separately and then to insert the rupture disc with the membrane into the additional opening. In this way, installation is simplified and subsequent damage to the rupture disc is essentially excluded. In this way, a comparatively cost-effective fluidic connection of the membrane to the rupture disc has also been achieved. In addition, it is useful in this way to manufacture the rupture disc, with the membrane attached to it, as a module, wherein the material properties of the membrane are already coordinated with the rupture disc. For the specific application, one of a number of modules is used as an example.

The wall thickness of the cell casing, preferably of the possible base body, can be reduced in the rupture region. In other words, the cell casing has a wall that encloses the rupture region. For example, the wall is flat or rounded. Adjacent to the rupture region, the thickness of the wall is increased. In particular, the thickness of the walls or all of the walls of the cell casing, with the exception of the rupture region, is constant, and the rupture region is in particular surrounded by a step on the edge. The wall thickness of the cell casing in the rupture region is adapted in particular to the bursting pressure. For example, the cell casing is originally shaped with the reduced wall thickness in the rupture region. Alternatively, to create the rupture region, material is removed from one of the walls of the cell casing, for example by milling or a laser. For example, the wall thickness in the rupture region is constant. Alternatively, it varies in the rupture region so that when the bursting pressure is exceeded, the rupture region tears in a specific manner. For example, the rupture region is formed only by reducing the wall thickness. Alternatively, the rupture region has other components, such as the rupture disc. However, at least the opening is preferably located in the area of the reduced wall thickness of the cell casing.

Also, the cell casing can have one or more notches in the rupture region. By means of the notch(es), in particular at least part of the material of the cell casing, preferably of the base body, is removed, so that the notch represents a desired structural weakening of the cell casing, for example of the base body. If the bursting pressure is exceeded, the cell casing tears in the area of the notch or notches, so that material can escape from the cell casing there.

The notch(es) can be inserted, for example, after the original shaping of the cell casing, especially of the base body. This makes production easier. For example, the notch is designed to be closed, and thus is particularly shaped in the manner of a ring. Alternatively, the notch is elongated and has two ends spaced apart from each other. In another alternative, the notches or at least some of the notches are point-shaped and designed in the manner of a perforation. For example, the rupture region includes a number of notches that are designed as rings or circles. These are, for example, arranged concentrically to the opening which is thus surrounded by the notches. For example, in addition to the notch(es), the wall thickness of the cell casing is two-dimensionally reduced in the rupture region. In this way, comparatively precise setting of the bursting pressure is possible, wherein production is simplified.

In particular, the external contour of the rupture region can be delimited due to the notch(es). In other words, the, all or part of the notches run along the outer contour, i.e., the boundary of the rupture region. When the bursting pressure is exceeded, the rupture region tears along its outer contour, so that in particular the complete rupture region is opened. Thus, a comparatively rapid compensation of the pressure difference occurs. For example, there are additional notches in the rupture region, so that only comparatively small fragments are produced during tearing/breaking. Consequently, damage to other components due to the fragments is ruled out.

The battery cell particularly preferably may include a drying element. The drying element serves in particular to reduce moisture penetrating into the cell casing through the additional opening. The drying element is suitable for this purpose, in particular provided and set up. Due to the drying element, penetrating moisture, such as water (vapor), is thus bound, so that an unwanted reaction with the electrodes and/or any electrolytes arranged in the cell casing is prevented. This further increases operational reliability. In particular, the drying element is designed in such a way that it binds water, in particular absorbs water molecules. Appropriately, the drying element has silicate or is made of it. In this way, the drying effect is further improved.

The drying element can surround the opening. In this way, a drying effect in the area of the fluidic connection between the inner and outer cell casing is improved. Preferably, the drying element is thus designed in the style of a hollow cylinder, which facilitates production. For example, the drying element is located on the outside or the inside of the rupture region. Preferably, the drying element, as compared to the membrane, is offset into the inside of the cell casing, so that the moisture that penetrates the cell casing despite the existence of the membrane is bound by means of the drying element.

The invention further relates to a composite of such battery cells, wherein the composite is preferably a battery module or a high-voltage battery. Furthermore, the invention relates to a motor vehicle, such as a passenger car with such a battery cell, in particular such a composite. The battery cell is used in particular to power the main drive of the motor vehicle.

The advantages and further developments described in connection with the battery cell can also be applied to the network/the motor vehicle as well as to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically simplified, a motor vehicle which has several identical battery cells,

FIG. 2 schematically in a sectional view, one of the battery cells comprising a cell casing with a rupture region,

FIG. 3 shows in perspective in a sectional view, the cell casing, wherein the rupture region includes a rupture disc,

FIGS. 4 to 7 show in each case schematically in a sectional view, variants of the cell casing, wherein the rupture region has an opening covered with a gas-permeable membrane, and

FIGS. 8 and 9 show in each case schematically in perspective in a sectional view, further variants of the cell casing.

### DETAILED DESCRIPTION

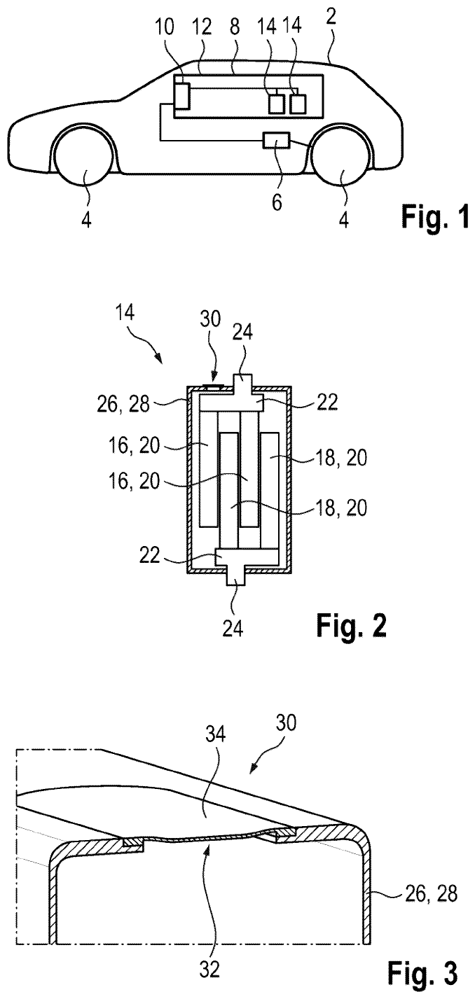

FIG. 1 shows a motor vehicle 2 in the form of a passenger car in a schematically simplified manner. The motor vehicle 2 has a number of wheels 4, at least some of which are driven by a drive 6, which includes an electric motor. Thus, the motor vehicle 2 is an electric vehicle or a hybrid vehicle. The drive 6 has an inverter by means of which the electric motor is powered. The inverter of the drive 6, in turn, is powered by an energy storage unit 8 in the form of a high-voltage battery. For this purpose, the drive 6 is connected to an interface 10 of the energy storage unit 8, which is inserted into an energy storage casing 12 of the energy storage unit 8, which is made of stainless steel.

Within the energy storage casing 12 of the energy storage unit 8, a number of unspecified battery modules of identical construction are arranged, each of which comprises a number of battery cells 14. The battery cells 14 of each battery module are connected to each other, partly electrically in series and partly electrically parallel to each other. Some of the battery modules, in turn, are electrically connected in series to each other, and these in turn are electrically connected to each other in parallel. The electrical composite of the battery modules is electrically contacted with the interface 10, so that when the drive 6 is in operation, the battery modules and thus also the battery cells 14 are discharged or charged (recuperation). Due to the electrical interconnection, the electrical voltage provided at the interface 10, which is 400 V, is a multiple of the electrical voltage provided by each of the battery modules and also by each of the battery cells 14.

FIG. 2 shows one of the identical battery cells 14 in a sectional view. The battery cell 14 has a number of anodes 16 and cathodes 18, of which only two are shown. The anodes 16 and cathodes 18, which form the electrodes 20 of the battery cell 14, are each designed flat and alternately stacked on top of each other to form a cell stack, wherein an unspecified separator is arranged between adjacent anodes 16 and cathodes 18. The anodes 16 project beyond the cathodes 18 on a common side, namely a respective collector formed by means of a respective metal foil. In the area of the projection, the respective collector is free of other components, but in the other areas a layer is applied to the respective collector, also known as the carrier, which contains an active material. The cathodes 18 project beyond the anodes 16 in the same way, wherein the projections are located on opposite sides of the stack formed by means of the anode 16 and the cathodes 18.

The projections of the anodes 16 and cathodes 18 are each welded to an assigned busbar 22, which is made of copper. Here, the anodes 16 and cathodes 18 are each assigned one of the busbars 22. The busbars 22 each have a connector 24, which is routed through a base body 26 of a cell casing 28 within which the anodes 16 and the cathodes 18 are arranged. Thus, the electrodes 20 are arranged within the cell casing 28. The base body 26 is rigidly designed and made of aluminum. Thus, the battery cell 14 is a prismatic cell. The base body 26, and thus the cell casing 28, is filled with an unspecified liquid electrolyte.

The cell casing 28 comprises a rupture region 30, which has an area of 5 cm2. The rupture region 30 is designed in such a way that a pressure difference between the pressure outside the cell casing 28, namely of the base body 26, and the pressure inside the cell casing 28, namely of the base body 26, which exceeds a bursting pressure of 1 bar, breaks so that the cell casing 28 is open and pressure equalization can take place. The bursting pressure is 90% of the maximum compressive load of the base body 26, i.e., the pressure difference at which an irreversible and uncontrolled destruction of the base body 26 occurs. The bursting pressure represents a second limit value here.

FIG. 3 shows the cell casing 28 with the cuboid base body 26 in perspective in sections. An additional stadium-shaped opening 32 is inserted into the base body 26, which is closed by means of a rupture disc 34 of the cell casing 28. In other words, the rupture disc 34 is inserted into the additional opening 32, wherein the edge of the rupture disc 34 overlaps the edge of the additional opening 32 and is fastened to it by means of welding to make it fluid-tight and gas-tight. The cell casing 28 is designed in such a way that the base body 26 and the rupture disc 34 are flush with each other on the outside. By means of the rupture disc 34, the rupture region 30 is defined, in a way that the rupture region 30 includes the rupture disc 34. The size of the additional opening 32 is equal to the size of the rupture region 30. If the bursting pressure is exceeded, the rupture disc 34 tears or breaks completely, so that the additional opening 32 is uncovered.

The rupture disc 30 is made of an aluminum and has a reduced thickness than the wall thickness of the cell casing 26. The additional opening 32 is located in the same wall of the base body 26 into which the opening for one of the connectors 24 is also inserted. With the exception of the additional opening 28, the base body 26 is designed to be fluid-tight and gas-tight. For example, the areas between the connectors 24 and the openings of the base body 26 assigned to the latter are filled with an unspecified plastic.

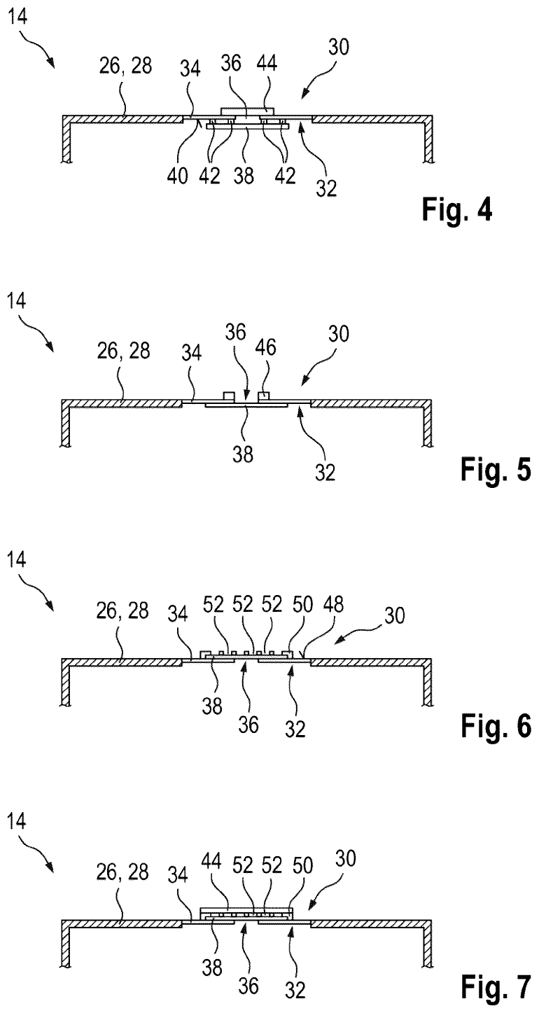

FIG. 4 schematically shows the battery cell 14 in a sectional view. The rupture disc 34 and thus also the rupture region 30 have an opening 36 in their middle, which is circular. The opening 36 has a reduced area of 1 mm2 as compared to the additional opening 32. The opening 36 is covered with a gas-permeable membrane 38, which is at least partly made of PTFE and has a crystallinity between 85% and 100% and a density between 0.2 g/cm3 and 2 g/cm3. Thus, gas passage of H2 and CO2 through the membrane 38 is comparatively easy, whereas the passage of moisture, especially water vapor, is more difficult in comparison. The area of the membrane 38, which is concentric to the opening 36 and is also round in shape, is three times the area of the opening 36 in this example.

The membrane 38 is located on an inward-facing side 40 of the rupture disc 34 and thus of the rupture region 30. In other words, the membrane 38 is placed, in relation to the rupture disc 30 and the other rupture region 30, in the interior of the base body 26 and therefore also of the cell casing 28. Between the membrane 38 and the rupture disc 34, web-shaped spacers 42 are arranged by means of which the membrane 38 is partially supported on the rupture disc 34 and thus also on the rupture region 30. In other words, the membrane 34 is spaced from the rupture region 30, namely by the thickness of the spacers 42.

One of the spacers 42 is arranged at the edge of the membrane 38 and is circumferential so that it is circular or ring-shaped. This spacer 42 is gas- and liquid-tightly, i.e., fluid-tightly, attached to the rupture disc 34, namely by means of laser welding. The other spacers 42, on the other hand, only loosely rest against the rupture disc 34, and by means of this, in contrast to the ring-shaped spacer 42, no complete spatial area is enclosed on the circumferential side. All spacers 42 are molded to the membrane 38 and are made of the same material and in the same step.

The membrane 38 is designed in such a way that it tears when the pressure difference between the pressure outside the cell casing 28 and the pressure inside the cell casing 28 exceeds a first limit value. The first limit value is 50% lower than the bursting pressure, i.e., the second limit value. As soon as the tearing has begun, it continues until the pressure differential falls below the first limit value. When this is the case, the tearing stops.

The opening 36 is covered by an additional membrane 44 which is located on the outer side of the rupture disc 34 and thus also of the rupture region 30. Thus, the additional membrane 44 is offset to the outside in relation to the rupture disc 34/the rupture region 30, and the opening 36 is covered on each side by one of the membranes 38, 44. The additional membrane 44 is gas-permeable, but also hydrophobic. In other words, water is rejected by means of the additional membrane 44. The additional membrane 44 is also fluid-tightly attached to the rupture disc 34.

When the battery cell 14 is in operation, it is possible that due to unintentional chemical reactions, for example due to a comparatively high load or due to unwanted foreign particles, gases such as H2 and/or CO2 form in the cell casing 28. The gases 36 require a larger volume than the reactants, so that the pressure within the cell casing 28 increases. Thus, there is an increased pressure inside the cell casing 28 as compared to the outside of the cell casing 28. In other words, the ambient pressure around the cell casing 28 is less than the pressure inside the cell casing 28.

As a result, the gases, or at least some of the gases, escape through the membrane 38 as well as through the opening 36 and the additional membrane 44 into the environment of the battery cell 14, so that pressure equalization occurs. Since the area of the membrane 38 is comparatively large, a comparatively large volume of gases can be removed. Part of it passes through the area of the membrane 38, which is covered by the rupture disc 34. Subsequently, there is no further fluidic resistance for this part to pass through the opening 36, since with the exception of the outermost of the spacers 42, no space is completely enclosed. In other words, these spacers 42 do not hinder the further flow of gases. The outermost of the spacers 42 prevent the gases or any other fluid between the rupture disc 34 and the membrane 38 from flowing out of or into the cell casing 28 without passing through the membrane 38.

The gases flowing outward through the opening 36 pass through the additional membrane 44 and thus escape. By means of the membrane 44, the penetration of water in a liquid or gaseous state and also of water vapor into the opening 36 and thus also into the interior of the cell casing 28 is prevented. If moisture nevertheless reaches the membrane 38, it is retained by the membrane 38, which has a comparatively high impermeability to moisture. This prevents moisture from outside the cell casing 28 from entering it and leading to undesirable reactions with the electrodes 20.

If, due to special circumstances such as excessive loading, the volume of gases transmitted by the membrane 38 is not sufficient to limit the pressure difference to below 0.5 bar, i.e., the first limit value, the membrane 38 begins to tear. As a result, an increased volume of gases can pass through, so that the increase in pressure is limited or at least slowed down. If this is sufficient to eliminate the pressure difference, subsequent operation of the battery cell 14 is also possible in the future, wherein the penetration of moisture from the outside into the cell casing 28 is then only partially prevented by means of the membrane 38. As an alternative to or in combination with the tearing of the membrane 38, the fluid-tight connection of the outer most spacer 42 at the rupture disc 34 also begins to dissolve when the pressure difference is greater than the first limit value, so that the gases can also escape up to the opening 36 and from there into the surrounding area.

If, even with a completely torn/detached membrane 38, i.e., if the opening 36, with the exception of the additional membrane 44, is completely opened, the pressure increase is not limited and exceeds the bursting pressure, i.e., the second limit value, then the rupture disc 34 breaks, so that the additional opening 32 is opened. Thus, the volume of gases that can escape from the cell casing 28 is further increased, wherein there is essentially no more fluidic resistance. This reduces the pressure difference comparatively quickly and, as a result, prevents uncontrolled destruction of the base body 26, which could lead to damage to objects arranged near the battery cell 14. However, it is also possible that the electrolyte leaks out of the additional opening 32, so that the battery cell 14 is no longer operational.

FIG. 5 shows a modification of the battery cell 14, wherein the additional opening 32 as well as the position of the rupture disc 34 and its attachment to the base body 26 are not changed. The rupture disc 34, i.e., the rupture region 30, also continues to include the opening 36, which has also not been modified. In this example, however, the rupture disc 34 is made of a polymer, and the thickness of the rupture disc 34 is adapted in such a way that it also breaks at the bursting pressure of 1 bar. The opening 36 is also still completely covered by the membrane 38, which is offset to the inside of the base body 26 in relation to the rupture disc 34. The material of the membrane 38 is also not changed. However, the area of the membrane 38 is slightly reduced and this is mechanically directly attached to the rupture disc 34, i.e., the rupture region 30, and is attached to it by means of ultrasonic welding. Thus, a fluid-tight connection is directly realized between the membrane 38 and the rupture region 30.

In addition, the additional membrane 44 is omitted and the opening 36 is surrounded by a ring-shaped or hollow-cylindrical drying element 46, which is hydrophilic and made of a silicate. With the exception of the membrane 38, the opening 36 is therefore not covered. By means of the drying element 46, water impinging on the rupture region 30 from the outside in the area of the opening 36, and therefore also water vapor, is absorbed, so that it does not reach the opening 36. Thus, by means of the drying element 46, the penetration of moisture into the cell casing 28 is prevented or at least reduced. When the battery cell 14 is in operation, the drying element 46 is at least partially heated due to waste heat, so that any absorbed moisture is released again into the environment and transported away. This means that the drying element 46 is ready for use for a comparatively long period of time.

The operation of the membrane 38 and the rupture disc 34 has not been altered as compared to the previous examples. However, in this variant, the effective area provided for the passage of gases through the opening 36 by means of the membrane 38 is equal to the area of the opening 36. In other words, the volume of gases that can pass through the membrane 36 is reduced. Therefore, in this variant of the battery cell 14, the increase in pressure in the cell casing 28 is reduced or limited only to a small extent until the membrane 38 tears or the rupture disc 34 bursts.

FIG. 6 shows a further modification of the battery cell 14, wherein the cell casing 26 and the additional opening 32, which is closed by means of the rupture disc 34, are not changed. For example, the rupture disc 34, and therefore also the rupture region 30, continues to have the opening 36. The membrane 38 is again present, wherein the expansion of the membrane 38 essentially corresponds to the variant shown in FIG. 3. However, the membrane 38 is now attached at the edge of the opposite side of the rupture disc 30, i.e., to an outer side 48 of the cell casing 28, namely to the outward-facing side of the rupture region 30, namely by means of thermal welding. Otherwise, the membrane 38 is not attached to the rupture disc 34 and only rests loosely on the rupture disc 34 in the other areas.

The battery cell 14 also has a stabilizing element 50, by means of which the membrane 38 is completely covered and which protrudes slightly beyond the edge of the membrane 38. Thus, the membrane 38 rests on the outside of the stabilizing element 50, which is made of a metal. The edge area of the stabilizing element 50 is designed to be continuous and is welded to the rupture region 30, namely the rupture disc 34, and is therefore fluid-tightly connected to it. With the exception of the edge, the stabilizing element 50 is designed in the manner of a lattice and thus has a large number of additional openings 52.

When the battery cell 14 is in operation, any gases produced first enter the environment through the opening 36 and then through the membrane 38 and the additional openings 52. Due to the fact that the membrane 38 is only loosely attached to the rupture disc 34, with the exception of the fastening on the edge, it is possible for the gases to accumulate in the area formed between the membrane 38 and the rupture disc 34, so that a comparatively large area of the membrane 38 is available for the passage of gases. In this case, the membrane 38 is partially bulged/arched outwards, wherein excessive bulging is prevented by means of the stabilizing element 50. Thus, in each of the additional openings 52 this results in a corresponding bulge of the membrane 38. Due to the bulge or arch, the area of the membrane 38 available for the passage of the gases is further increased. However, excessive deformation of the membrane 38 is prevented by means of the stabilizing element 50, so that damage to the membrane 38 is avoided. The mechanical connection of the membrane 38 with the rupture disc 34 is also stabilized by means of the stabilizing element 50, so that the membrane 38 is prevented from tearing off from the rupture disc 34.

If the pressure difference between the pressure inside the cell casing 28 and the pressure outside the cell casing 28 exceeds the first limit value, the stabilizing element 50 breaks at least partially, so that the stabilization function of the membrane 38 is canceled. As a result, the membrane 38 tears, which is why it is still possible for an increased volume of gases to escape.

FIG. 7 shows another modification of the battery cell 14. This variant is essentially the same as the previous example, but the stabilizing element 50 is covered on the outside with the additional membrane 44. Thus, the stabilizing element 50 is located between the two membranes 38, 44. By means of the additional membrane 44, the penetration of moisture into the additional openings 52 and thus up to the membrane 38 is prevented, wherein it is still possible for the gases the escape from the cell casing 28.

In an unspecified variant, instead of the additional membrane 44 or additionally, the drying element 46 is present by means of which the stabilizing element 50 is surrounded, or which rests on the edge of the stabilizing element 50, so that the opening 36 is surrounded by it.

In variants that are not shown in more detail, either in the example according to FIG. 6 or in the example according to FIG. 7, the stabilizing element 50 is not present, and the membrane 38 is designed to be more stable. If the gases accumulate between the membrane 38 and the rupture disc 34, the membrane 38 thus bulges comparatively widely, avoiding tearing. This only takes place when the first limit value is exceeded.

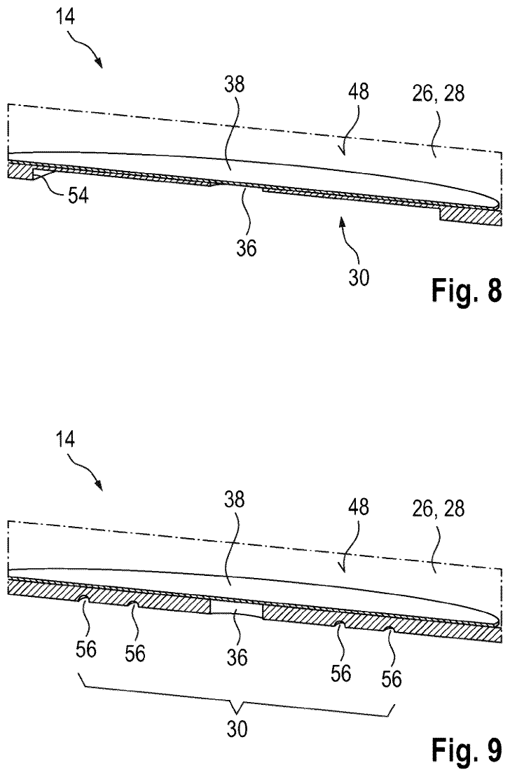

FIGS. 8 and 9 show variants of the battery cell 14, with the rupture region 30 changed in each case. This continues to have the opening 36, which is covered by means of the membrane 38. In each of the variants shown, the membrane 38 is attached to the outer side 48 of the cell casing 28, namely by means of welding. In the two variants shown, neither the additional membrane 44 nor the drying element 46 or the stabilizing element 50 are present. However, in the case of unspecified variations, the battery cell 14 is further developed in accordance with the variants shown in FIGS. 4-7, with the rupture region 30 being designed in accordance with the version shown in FIG. 8 and FIG. 9.

In the variant shown in FIG. 8, a wall thickness of the cell casing 28, namely the base body 26, is reduced in the rupture region 30. The rupture region 30 is molded to the base body 26 and is integral with this. As compared with the base body 26, however, the wall thickness in the rupture region 30 is reduced to 25%, so that the rupture region 30 is separated from the base body 46 by a circumferential step 54. In other words, the step 54 forms the transition from the rupture region 30 to the base body 26. The wall thickness in the rupture region 30 is constant. The rupture region 30 is round and arranged concentrically to the opening 36.

To produce the rupture region 30, material is removed from the base body 26, which has a continuous wall thickness, to form the rupture region 30, for example by milling or by using a laser. In the variant shown, the material is removed from the inner side, so that the outer side of the cell casing 28 is flat. This makes it easier to attach the membrane 38.

In the variant shown in FIG. 9, the rupture region 30 has essentially the same wall thickness as the base body 26, and the rupture region 30 is also integral with the base body 26. The rupture region 30 is separated from the base body 26 by means of a circumferential notch 56, which is also inserted into the base body 28 after its completion to create the rupture region 30. Consequently, the outer contour of the rupture region is delimited by means of the notch 56. The notch 56 is arranged in a ring and concentric to the opening 36. In addition, the rupture region 30 has another notch 56, which is also ring-shaped but has a reduced diameter. Thus, the rupture region 30 comprises the two notches 56 arranged concentrically to the opening 36, which represent a structural weakening of the cell casing 26.

In the variants of the rupture region 30 shown in FIG. 8 and FIG. 9, the weakening of the cell casing 28 by reducing the wall thickness or the notches 56 is such that the rupture region 30 breaks when the bursting pressure is exceeded, so that an increased volume of gas can escape from the cell casing 26. Here, too, uncontrolled damage to the base body 26 in the event of an increase in pressure is avoided.

The invention is not limited to the embodiments described above. Rather, other variants of the invention can also be derived from this by the skilled person without departing from the subject matter of the invention. In particular, all the individual features described in connection with the individual embodiments can also be combined with each other in other ways without departing from the subject matter of the invention.

What is claimed is:

1. A battery cell comprising:
a cell casing, in which at least two electrodes are arranged; and
a rupture region having an opening that is covered by a gas-permeable membrane.

2. The battery cell according to claim 1, wherein the membrane is designed such that it tears when a pressure difference between a pressure outside the cell casing and a pressure inside the cell casing exceeds a first limit value.

3. The battery cell according to claim 2, wherein the rupture region is designed such that it breaks when the pressure difference between the pressure outside the cell casing and the pressure inside the cell casing exceeds a second limit value that is greater than the first limit value.

4. The battery cell according to claim 1, wherein the membrane is attached to an outer side of the cell casing.

5. The battery cell according to claim 4, wherein the membrane rests on a side facing away from the cell casing on a stabilizing element that has additional openings.

6. The battery cell according to claim 1, wherein the membrane is arranged on an inward-facing side of the rupture region, and wherein the membrane is partially supported on the rupture region via spacers.

7. The battery cell according to claim 1, wherein the cell casing comprises a base body with an additional opening into which a rupture disc is inserted, wherein the rupture region comprises the rupture disc.

8. The battery cell according to claim 1, wherein a wall thickness of the cell casing is reduced in the rupture region.

9. The battery cell according to claim 1, wherein the cell casing has a notch in the rupture region, via which an external contour of the rupture region is delimited.

10. The battery cell according to claim 1, wherein the opening is surrounded by a drying element.
